(19) United States
(12) Patent Application Publication
(10) Pub. No.: US 2025/0271032 A1
(43) Pub. Date: Aug. 28, 2025

(54) CROWN-TYPE RETAINER FOR BALL BEARING, AND BALL BEARING

(71) Applicant: NSK LTD., Tokyo (JP)

(72) Inventor: Masahito MATSUI, Kanagawa (JP)

(73) Assignee: NSK LTD., Tokyo (JP)

(21) Appl. No.: 18/856,519

(22) PCT Filed: Mar. 6, 2023
(86) PCT No.: PCT/JP2023/008431

§ 371 Date: Oct. 11, 2024

(30) Foreign Application Priority Data
Apr. 15, 2022 (JP) 2022-067904

(51) Int. Cl. F16C 33/41; F16C 19/06

(52) U.S. Cl. CPC F16C 33/418; F16C 19/06

(57) ABSTRACT

A crown cage for a ball bearing includes an annular main portion, pillar portions protruding in an axial direction at predetermined intervals in a circumferential direction from the main portion, and a pocket formed between the adjacent pillar portions and having a spherical concave surface capable of holding a ball. The pillar portion includes a pair of claw portions having tip end portions arranged at intervals therebetween and a connection portion connecting the pair of claw portions. An inlet portion having a width shorter than a diameter of the ball and for inserting the ball is provided between the tip end portions of the two adjacent claw portions constituting the pocket. A distance from an outer circumferential surface of the pocket to a center of the crown cage for a ball bearing is larger than a distance from an outer circumferential surface of the pillar portion to the center.

### TECHNICAL FIELD

The present invention relates to a crown cage for a ball bearing and a ball bearing.

### BACKGROUND ART

FIG. 12 is a cross-sectional view of a ball bearing 1 according to an example in the related art. Generally, the ball bearing 1 as shown in FIG. 12 is used to support a rotating portion of various rotary machines. The ball bearing 1 includes an inner ring 3 having an inner ring raceway 2 on an outer circumferential surface thereof, an outer ring 5 disposed concentrically with the inner ring 3 and having an outer ring raceway 4 on an inner circumferential surface thereof, and a plurality of balls 6 rollably disposed between the inner ring raceway 2 and the outer ring raceway 4.

Each ball 6 is rollably held by a cage 100. Outer circumferential edges of a pair of circular ring-shaped shield plates 7, 7 are respectively engaged with both axial end portions of the inner circumferential surface of the outer ring 5. The pair of shield plates 7, 7 prevent a lubricant such as grease present in a bearing space from leaking to the outside or prevent dust floating outside from entering the bearing space. Instead of the non-contact type shield plates 7, 7, a contact type seal may be used as a sealing device.

The cage 100 is a crown cage made of a resin. FIG. 13 is a perspective view of the cage 100 according to the example in the related art. FIG. 14 is a view of a portion of the cage 100 according to the example in the related art as viewed from a radially inner side. FIG. 15 is a top view of the portion of the cage 100 according to the example in the related art. As shown in FIGS. 13 to 15, the cage 100 includes an annular main portion 101, a plurality of pillar portions 102 protruding in an axial direction at predetermined intervals in a circumferential direction from the main portion 101, and pockets 103 each having a spherical shape formed between the adjacent pillar portions 102 and capable of holding the ball 6.

The pillar portion 102 has a pair of claw portions 105, 105 whose tip end portions are arranged at intervals. Since the two adjacent claw portions 105, 105 constituting the pocket 103 hold the ball 6, the cage 100 is prevented from falling off in the axial direction from between the outer ring 5 and the inner ring 3. Further, a thinned portion 109 is formed on a bottom surface side of the pillar portion 102.

In recent years, a rolling bearing (in particular, a ball bearing) that supports a rotating shaft of a motor has been required to be rotated at a high speed with the motorization of an automobile. To achieve the high-speed rotation, it is necessary to (i) prevent fatigue failure by suppressing expansion of the pillar portions of the cage due to a centrifugal force and reducing a stress generated at a bottom portion of the pocket, and (ii) avoid contact of the cage with the outer ring and the seal by suppressing deformation of the cage, thereby suppressing wear, vibration, and heat generation of the cage.

In the cage 100 in the related art as shown in FIGS. 13 to 15, the stress may act on the cage 100 due to the centrifugal force during the high-speed rotation, and the cage 100 may be deformed toward an outer diameter side. In FIG. 12, a state in which the cage 100 is deformed is shown by a dashed line. In this case, the cage 100 may come into contact with the outer ring 5 (see a portion A in FIG. 12), the cage 100 may come into contact with the shield plate 7 (see a portion B in FIG. 12), and the cage 100 may wear, vibrate, or generate heat.

A cage described in Patent Literature 1 includes an annular base portion and an axial portion extending in an axial direction from the base portion. An outer diameter of the axial portion is smaller than an outer diameter of the base portion. The base portion is formed with a hole that communicates with a recessed area of the axial portion and penetrates in the axial direction. Accordingly, the amount of a material is reduced to keep the mass low, and deformation in a radial direction induced during the high-speed rotation is suppressed.

### CITATION LIST

### Patent Literature

Patent Literature 1: JP5436204B

### SUMMARY OF INVENTION

### Technical Problem

However, for a bearing having a small size, if a hole communicating with the recessed

area of the axial portion and penetrating in the axial direction is formed in the base portion as shown in Patent Literature 1, the periphery of the hole becomes too thin, and there is a possibility that strength is reduced.

Further, since a crown cage made of a resin is generally manufactured by injection molding in which the resin is poured into a mold, the crown cage needs to have a thickness necessary for the resin to flow. However, in the cage described in Patent Literature 1, since the annular base portion connecting the pockets is branched into two, good fluidity of the resin is not ensured, and the moldability of the cage is not necessarily good. Therefore, it is necessary to change the shape to a shape in consideration of moldability.

The present invention has been made in view of the above circumstances, and an object thereof is to provide a crown cage for a ball bearing and a ball bearing capable of suppressing deformation of the cage and reducing stress, and having good moldability.

### Solution to Problem

The above object of the present invention is achieved by the following configuration.

(1) A crown cage for a ball bearing includes:
an annular main portion;
a plurality of pillar portions protruding in an axial direction at predetermined intervals in a circumferential direction from the main portion; and
a pocket formed between the adjacent pillar portions and having a spherical concave surface having a spherical shape capable of holding a ball, in which
the pillar portion includes a pair of claw portions having tip end portions arranged at intervals therebetween and a connection portion connecting the pair of claw portions,
an inlet portion having a width shorter than a diameter of the ball and for inserting the ball is provided between the tip end portions of the two adjacent claw portions constituting the pocket, and
a distance from an outer circumferential surface of the pocket to a center of the crown cage for a ball bearing is larger than a distance from an outer circumferential surface of the pillar portion to the center.

(2) The crown cage for a ball bearing according to the above (1), in which
a convex portion protruding in the axial direction is provided on a bottom surface of the main portion, and
at least a portion of the convex portion overlaps the pocket in the circumferential direction and a radial direction.

(3) A ball bearing includes:
an outer ring;
an inner ring;
a plurality of the balls arranged between the outer ring and the inner ring; and
the crown cage for a ball bearing according to the above (1) or (2).

### Advantageous Effects of Invention

According to the crown cage for a ball bearing and the ball bearing of the present invention, deformation of the cage can be suppressed, stress can be reduced, and moldability is good.

### BRIEF DESCRIPTION OF DRAWINGS

FIG. 1 is a perspective view of a cage according to a first embodiment.

FIG. 2 is a top view of a portion of the cage according to the first embodiment.

FIG. 3 is a view of the portion of the cage according to the first embodiment as viewed from a radially outer side.

FIG. 4 is a view of the portion of the cage according to the first embodiment as viewed from a circumferential direction.

FIG. 5 is a perspective view of a cage according to a second embodiment.

FIG. 6 is a top view of a portion of the cage according to the second embodiment.

FIG. 7 is a view of the portion of the cage according to the second embodiment as viewed from a radially outer side.

FIG. 8 is a view of the portion of the cage according to the second embodiment as viewed from a circumferential direction.

FIG. 9 Sections (a) to (c) of FIG. 9 are views showing a maximum principal stress distribution generated in the cages by a centrifugal force.

FIG. 10 is a diagram for illustrating a model for analysis.

FIG. 11 Sections (a) and (b) of FIG. 11 are diagrams showing strain distribution when strain is maximized in the cages of the first and second embodiments.

FIG. 12 is a cross-sectional view of a ball bearing according to an example in the related art.

FIG. 13 is a perspective view of a cage according to the example in the related art.

FIG. 14 is a view of a portion of the cage according to the example in the related art as viewed from a radially inner side.

FIG. 15 is a top view of the portion of the cage according to the example in the related art.

### DESCRIPTION OF EMBODIMENTS

Hereinafter, a crown cage for a ball bearing and a ball bearing according to an embodiment of the present invention will be described below with reference to the drawings.

### First Embodiment

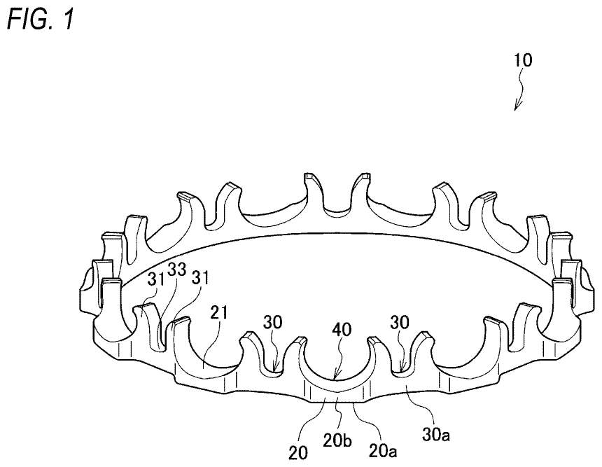

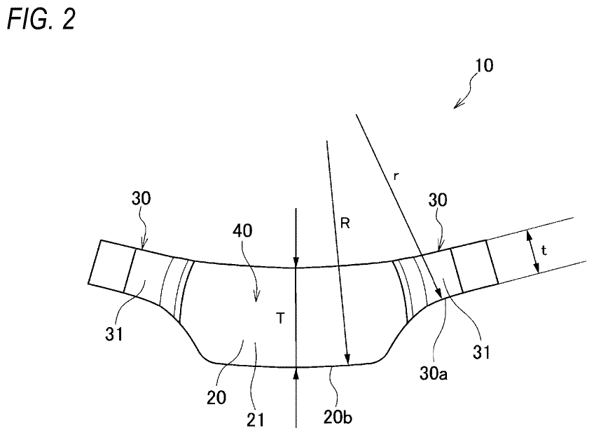

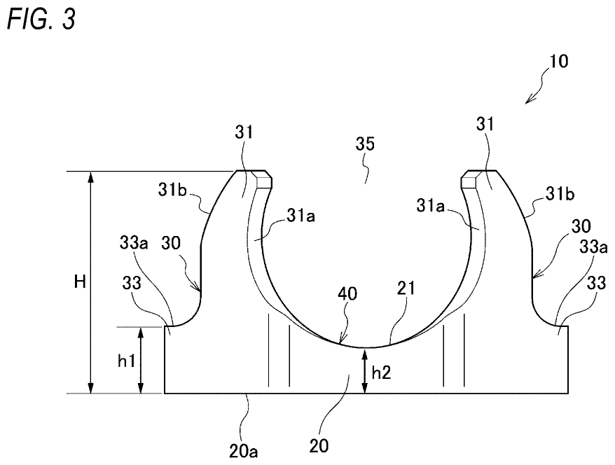

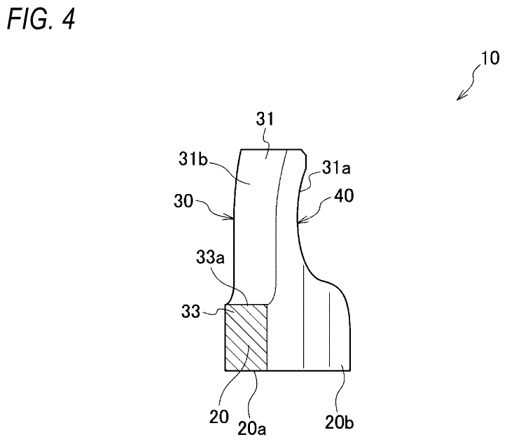

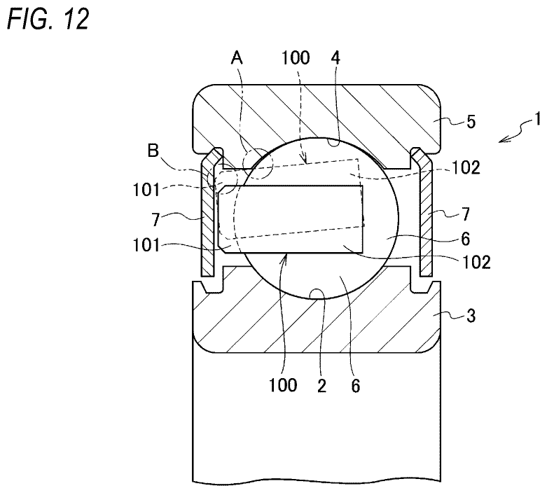

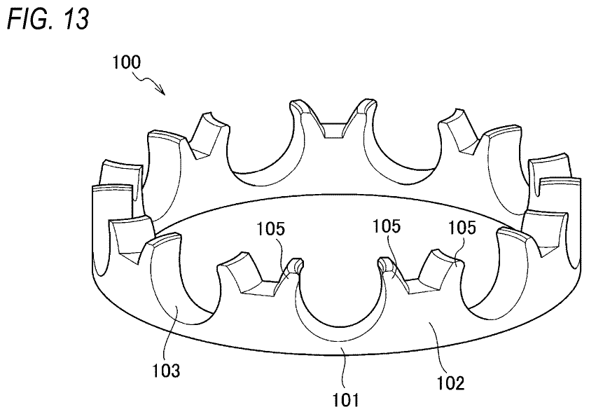

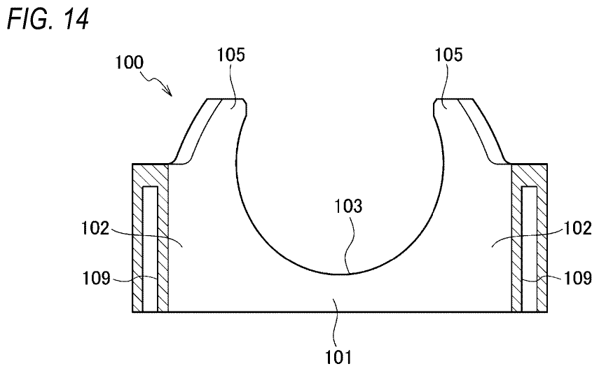

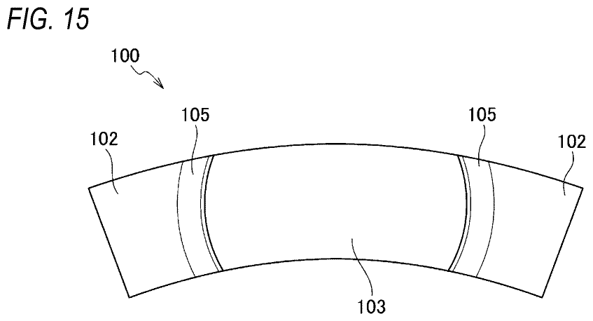

FIG. 1 is a perspective view of a cage 10 according to a first embodiment. FIG. 2 is a top view of the portion of the cage 10 according to the first embodiment. FIG. 3 is a view of the portion of the cage 10 according to the first embodiment as viewed from a radially outer side. FIG. 4 is a view of the portion of the cage 10 according to the first embodiment as viewed from a circumferential direction. As shown in FIGS. 1 to 4, similarly to a cage 100 in the related art shown in FIGS. 13 to 15, the crown cage for a ball bearing (hereinafter, referred to as a “crown cage” or also simply referred to as a “cage”) 10 of the present embodiment can be applied to a ball bearing 1 shown in FIG. 12.

The crown cage 10 is made of a resin material such as nylon 46 (polyamide 46, PA46), nylon 66 (polyamide 66, PA66), polyamide 9T (PA9T), polyamide 10T (PA10T), L-PPS, PEEK, or the like, or another resin material. In order to improve the strength of the cage 10, a resin composition in which a fiber reinforcing material (carbon fiber, glass fiber, aramid fiber, or the like) is added in a number of 10% (for example, 10 wt % to 50 wt %) may be used. Examples of a method for manufacturing the cage 10 include an injection molding method using a mold, and a manufacturing method using a 3D printer.

The crown cage 10 includes a substantially annular main portion 20, a plurality of pillar portions 30 protruding in an axial direction at predetermined intervals in the circumferential direction from the main portion 20, and pockets 40 each having a spherical shape formed between the adjacent pillar portions 30, 30 and capable of holding a ball 6 (see FIG. 12).

A plurality of spherical concave surfaces 21 each having a spherical shape are formed at predetermined intervals in the circumferential direction on an upper surface of the main portion 20. The spherical concave surface 21 is formed over an entire radial width of the main portion 20, and constitutes the pocket 40.

The pillar portion 30 protrudes from the main portion 20 in the axial direction. The pillar portion 30 includes a pair of claw portions 31, 31 and a connection portion 33 connecting the pair of claw portions 31, 31.

Tip end portions of the pair of claw portions 31, 31 are arranged at intervals in the circumferential direction. An inlet portion 35 having a width shorter than the diameter of the ball 6 (see FIG. 12) and for inserting the ball 6 is provided between the tip end portions of the two adjacent claw portions 31, 31 constituting the pocket 40.

The claw portion 31 includes a circumferential first surface 31a of a spherical shape constituting the pocket 40 and a circumferential second surface 31b opposite the circumferential first surface 31a.

The circumferential second surfaces 31b, 31b of the pair of claw portions 31, 31 have curved shapes respectively and are smoothly connected to each other on an upper surface 33a of the connection portion 33. The upper surface 33a of the connection portion 33 corresponds to a substantially U-shaped bottom portion formed by the upper surface 33a and the pair of circumferential second surfaces 31b, 31b. The upper surface 33a (a bottom portion of the pair of circumferential second surfaces 31b, 31b) of the connection portion 33 is positioned slightly above (one side in the axial direction) a bottom portion of the pocket 40. Accordingly, the bottom portion (the upper surface 33a of the connection portion 33) of the pair of circumferential second surfaces 31b, 31b is positioned below a center of the cage 10 in the axial direction (the other side in the axial direction), and forms a substantially U-shaped recessed portion. As shown in FIGS. 13 to 15, in the crown cage 100 in the related art, an upper surface of a connection portion (a bottom portion of a pair of circumferential second surfaces) is positioned much higher than an upper surface of the main portion 101, and is positioned above a center of the cage 100 in the axial direction (one side in the axial direction). Accordingly, the weight of the pillar portion 30 is reduced, and the mass of the pillar portion 30 is suppressed.

As described above, in the present embodiment, an axial width h1 from the upper surface 33a of the connection portion 33 to a bottom surface 20a of the main portion 20 is set to ½ or less of an axial width H of the cage 10 (h1≤H/2). If the axial width h1 is too small, the strength of the cage 10 may decrease, and thus the axial width h1 is preferably larger than an axial width h2 of the main portion 20 in a bottom portion of the pocket 40 (h1>h2).

The circumferential first surfaces 31a, 31a of the two adjacent claw portions 31, 31 and the spherical concave surface 21 of the main portion 20 constitute the pocket 40. The two circumferential first surfaces 31a, 31a and the spherical concave surface 21 are smoothly connected to each other to form a spherical concave surface of the pocket 40. A radius of curvature of the spherical concave surface of the pocket 40 is set to be larger than a radius of curvature of a rolling surface of the ball 6 (see FIG. 12).

As shown in FIG. 2, an outer diameter R of the pocket 40 (an outer diameter of the main portion 20 at a circumferential position where the pocket 40 is formed) is set to be larger than an outer diameter r of the pillar portion 30 and the claw portion 31. That is, the distance R from an outer circumferential surface of the pocket 40 (an outer circumferential surface 20b of the main portion 20 at the circumferential position where the pocket 40 is formed) to a center of the cage 10 is set to be larger than a distance r from an outer circumferential surface 30a of the pillar portion 30 to the center of the cage 10 (R>r).

Further, a radial width t of the pillar portion 30 is set to be equal to or less than a radial width T of the bottom portion of the pocket 40 (a radial width of the main portion 20 at the circumferential position where the bottom portion of the pocket 40 is formed) (t≤T).

That is, in the second embodiment, a configuration in which a region on a radially outer side of the pillar portion 30 (claw portions 31) is cut away is employed. In the crown cage 100 (see FIGS. 13 to 15) of the related art, since the pillar portion 102 protrudes in the axial direction from the entire radial width of the upper surface of the main portion 101, the pillar portion 30 (the claw portions 31) of the present embodiment differs in this respect.

As described above, according to the cage 10 of the present embodiment, the distance R from the outer circumferential surface of the pocket 40 to the center of the cage 10 is set to be larger than the distance r from the outer circumferential surface 30a of the pillar portion 30 to the center of the cage 10 (R>r). Accordingly, the cage 10 has a structure in which the portions other than the pockets 40, that is, the radially outer sides of the pillar portions 30 are cut away, and the weight is reduced. Further, since the cage 10 is not provided with a cutout for weight reduction as in the cage in the related art, moldability is also good.

Accordingly, even when the dimensions of the cage 10 are small, such as when the cage 10 is applied to a bearing having a small size, the cage 10 can be molded without deteriorating fluidity of the resin at the time of molding, and the weight can be reduced. As a result, deformation and stress due to centrifugal force during high-speed rotation can be suppressed. As a result, the cage 10 can be prevented from coming into contact with the outer ring 5, the shield plate 7, or the like, and wear, vibration, heat generation, and breakage of the cage 10 can be suppressed.

### Second Embodiment

Next, a crown cage for a ball bearing according to a second embodiment of the present invention will be described with reference to the drawings.

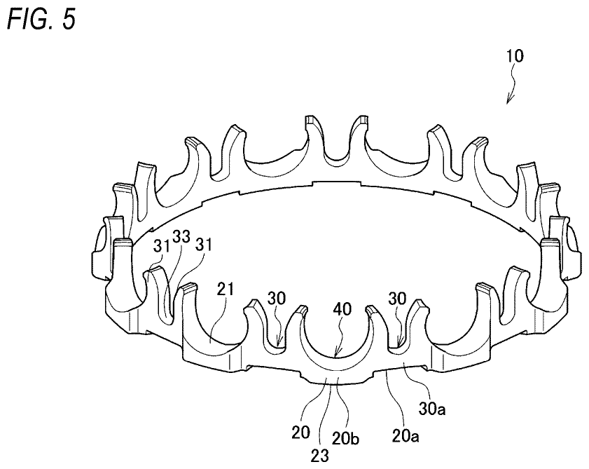

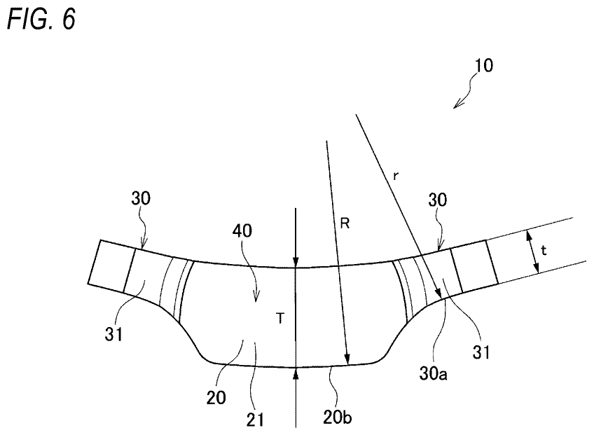

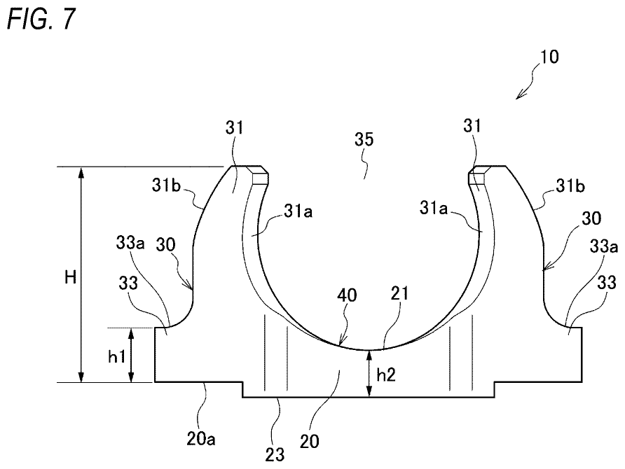

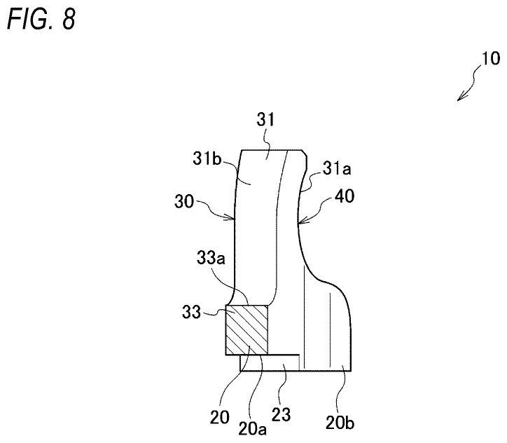

FIG. 5 is a perspective view of the cage 10 according to the second embodiment. FIG. 6 is a top view of a portion of the cage 10 according to the second embodiment. FIG. 7 is a view of the portion of the cage 10 according to the second embodiment as viewed from a radially outer side. FIG. 8 is a view of the portion of the cage 10 according to the second embodiment.

The cage 10 of the present embodiment is different from the cage 10 of the second embodiment (see FIGS. 1 to 4) in that convex portions 23 protruding to the other side in an axial direction are provided on the bottom surface 20a of the main portion 20. Since other configurations are the same as those of the first embodiment, the same reference numerals are given to the same components, and description thereof will be omitted or simplified.

The convex portion 23 protrudes from the bottom surface 20a of the main portion 20 toward the other side in the axial direction (a direction opposite to a direction in which the claw portion 31 extends in an upper-lower direction in FIG. 7) between the pillar portions 30, 30 adjacent to each other in the circumferential direction. That is, the bottom surface 20a of the main portion 20 has the plurality of convex portions 23 formed at predetermined intervals in the circumferential direction below the plurality of pockets 40.

At least a portion of the convex portion 23 preferably overlaps the pocket 40 in the circumferential direction and the radial direction. That is, a circumferential range and a radial range in which the convex portion 23 is provided are preferably substantially the same as a circumferential range and a radial range in which the spherical concave surface 21 of the main portion 20 constituting the pocket 40 is provided.

If the circumferential range in which the convex portion 23 is provided is too wide, the structure is substantially the same as that of the first embodiment, and an effect of reducing strain generated in the claw portions 31 at the time of incorporation to be described later is hardly obtained. If the circumferential range in which the convex portion 23 is provided is too narrow, a shortest distance between the spherical concave surface 21 and the root portions of both circumferential end portions of the convex portion 23 decreases, and a stress generated in the pocket 40 by the centrifugal force becomes higher than that generated on a pocket bottom. Further, since the radial range in which the convex portion 23 is provided is substantially the same as the radial range in which the spherical concave surface 21 is provided, a step is eliminated and generation of a high stress at the step is suppressed. Accordingly, the circumferential range and the radial range in which the convex portion 23 is provided are preferably substantially the same as the circumferential range and the radial range in which the spherical concave surface 21 of the main portion 20 constituting the pocket 40 is provided.

A radial width and a circumferential width of the convex portion 23 of the present embodiment are substantially the same as a radial width (the radial width of the main portion 20) and a circumferential width of the pocket 40.

According to the cage 10 of the second embodiment, the effect of suppressing the stress and the deformation generated by the centrifugal force compared to the first embodiment is not significantly different, but the effect is exerted when the cage 10 is incorporated into the ball bearing 1 consisting of the inner ring 3, the outer ring 5, and the balls 6. That is, the strain generated in the claw portions 31 of the cage 10 is reduced.

### Example 1

In order to confirm the effects of the first and second embodiments, analysis according to a finite element method was performed. In this analysis, when the cages 10 of the first and second embodiments and the cage 100 of an example in the related art (see FIGS. 13 to 15) were rotated, a maximum principal stress distribution generated in the cages 10, 100 by the centrifugal force was calculated.

A radial width of the cage 100 in the example in the related art was 3.3 mm. In the cages 10 of the first and second embodiments, the radial width T of the bottom portion of the pocket 40 is 3.3 mm. In the cage 10 of the second embodiment, an axial width of the convex portion 23 is 0.5 mm. The axial widths of all the cages 10, 100 were the same.

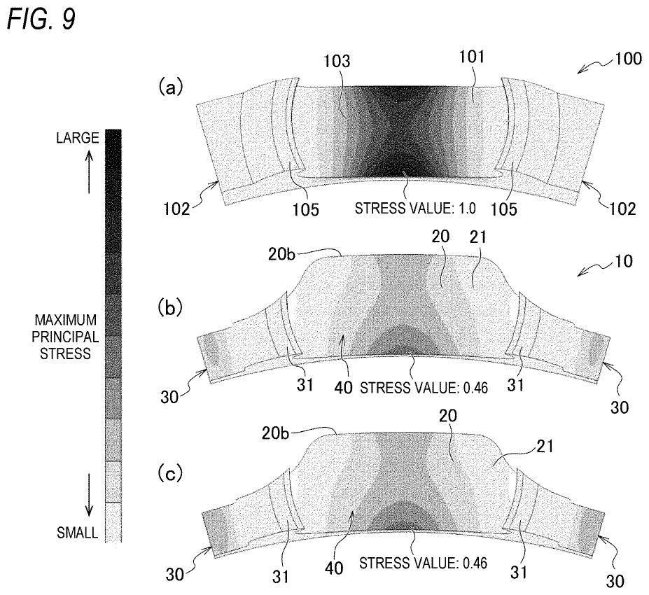

Material property values of each of the cages 10, 100 were a Young's modulus of 7210 MPa, a Poisson's ratio of 0.4, and a density of 1.27 g/cm³. As a condition, the rotational speed of the cage was 17,000 rpm. Sections (a) to (c) of FIG. 9 are views showing a maximum principal stress distribution generated in the cages 10, 100 by the centrifugal force. Section (a) of FIG. 9 corresponds to the cage 100 in the example in the related art, Section (b) of FIG. 9 corresponds to the cage 10 of the first embodiment, and Section (c) of FIG. 9 corresponds to the cage 10 of the second embodiment. Here, a stress value was a relative value. It is understood that the largest stress is generated in the cage 100 in the example in the related art. In contrast, in the cages 100 of the first and second embodiments, the stress generated at the pocket bottom is suppressed to half or less compared to the cage 100 in the example in the related art.

When the cage rotates, the centrifugal force acts, and the cage tends to spread radially outward. The magnitude of the centrifugal force is determined by the mass of the cage, a distance from a rotation center to the cage, a rotation speed, or the like. In the crown cage, since the respective pockets are connected to each other by the main portion, when the centrifugal force acts, the claw portions are tilted radially outward around the main portion by the centrifugal force acting on the claw portions. In the cages 10 of the first and second embodiments, since a radial width of the claw portion 31 is smaller than that of the cage 100 in the related art, the mass is reduced, and the centrifugal force acting on the claw portion 31 is reduced accordingly. Therefore, it is considered that the claw portion 31 is less likely to collapse and the stress generated at the pocket bottom is reduced.

### Example 2

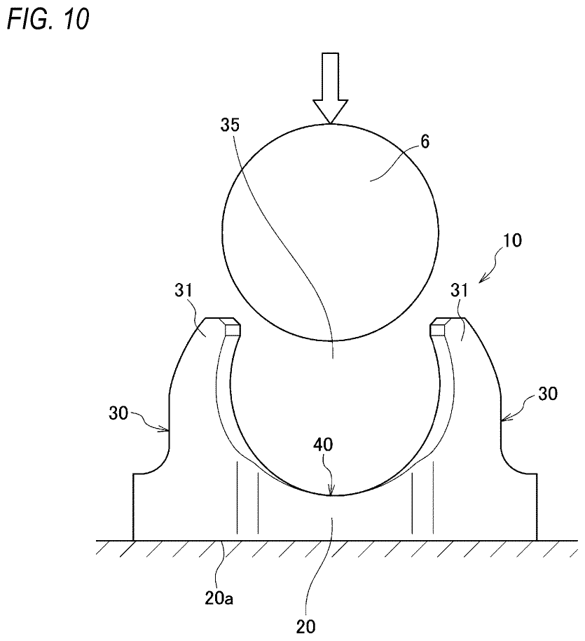

The strain generated in the claw portions 31 of the cage 10 when the cage 10 of the first embodiment having no convex portions 23 on the bottom surface 20a of the main portion 20 and the cage 10 of the second embodiment having the convex portions 23 on the bottom surface 20a of the main portion 20 were incorporated into the ball bearing 1 including the inner ring 3, the outer ring 5, and the balls 6 was analyzed by the finite element method and calculated. FIG. 10 is a diagram for illustrating a model for analysis. As shown in FIG. 10, in the model for analysis, a part of the cage 10 was taken out, and the ball 6 was gradually pushed in.

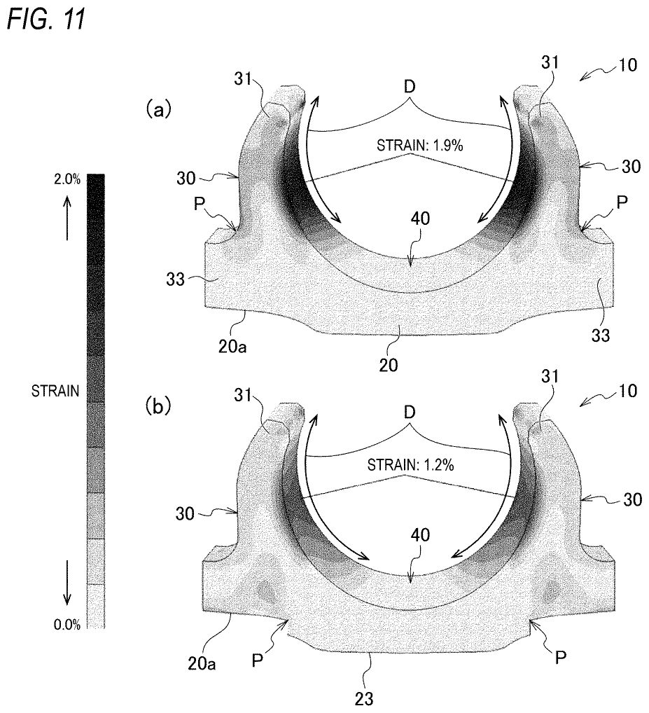

Section (a) and (b) of FIG. 11 are diagrams showing strain distribution when the strain is maximized in the cages 100 of the first and second embodiments. A maximum value of the strain generated in the claw portions 31 of the cage 10 of the first embodiment of Section (a) of FIG. 11 is 1.9%, and a maximum value of the strain generated in the claw portions 31 of the cage 10 of Section (b) of FIG. 11 is 1.2%. Since the strain is greatly reduced, it can be seen that the effect of reducing the strain is obtained by providing the convex portions 23.

This is because, as shown in Sections (a) and (b) of FIG. 11, when the ball 6 is pushed into the pocket 40 of the cage 10, the claw portion 31 is widened in the circumferential direction with a portion having low rigidity as a fulcrum P. That is, it is considered that the farther the fulcrum P is positioned from the tip end portion of the claw portion 31, the wider a strain generation region D becomes, and since the generated strain is dispersed, the maximum value is reduced.

In the cage 10 of the second embodiment shown in Section (b) of FIG. 11, compared with the cage 10 according to the first embodiment shown in Section (a) of FIG. 11, since a distance from the tip end portion of the claw portion 31 to the fulcrum P decreases, the strain generation region D is widened, and the strain further decreases as compared with Example 1.

When the cage 10 of the second embodiment is applied to a cage using a resin material such as polyamide 9T (PA9T) or polyamide 10T (PA10T) having a smaller elongation than nylon 46 or nylon 66, strain can be reduced, which is preferable.

Although various embodiments have been described above with reference to the drawings, the present invention is not limited to these examples. It is apparent for those skilled in the art to which the present invention belongs that various modified examples or corrected examples are conceivable within the scope recited in the claims, and it is understood that the above falls within the technical scope of the present invention. In addition, the components described in the above embodiments may be combined in any manner without departing from the spirit of the invention.

The present application is based on a Japanese Patent Application (No. 2022-067904) filed on Apr. 15, 2022, the contents of which are incorporated herein by reference.

### REFERENCE SIGNS LIST

1 ball bearing
2 inner ring raceway
3 inner ring
4 outer ring raceway
5 outer ring
6 ball
7 shield plate
10 crown cage for ball bearing
20 main portion
20a bottom surface
20b outer circumferential surface
21 spherical concave surface
23 convex portion
30 pillar portion
30a outer circumferential surface
31 claw portion
31a circumferential first surface
31b circumferential second surface
33 connection portion
33a upper surface
35 inlet portion
40 pocket
H, h1, h2 axial width

1. A crown cage for a ball bearing comprising:
an annular main portion;
a plurality of pillar portions protruding in an axial direction at predetermined intervals in a circumferential direction from the main portion; and
a pocket formed between the adjacent pillar portions and having a spherical concave surface having a spherical shape capable of holding a ball, wherein
the pillar portion includes a pair of claw portions having tip end portions arranged at intervals therebetween and a connection portion connecting the pair of claw portions,
an inlet portion having a width shorter than a diameter of the ball and for inserting the ball is provided between the tip end portions of the two adjacent claw portions constituting the pocket, and
a distance from an outer circumferential surface of the pocket to a center of the crown cage for a ball bearing is larger than a distance from an outer circumferential surface of the pillar portion to the center.

2. The crown cage for a ball bearing according to claim 1, wherein
a convex portion protruding in the axial direction is provided on a bottom surface of the main portion, and
at least a portion of the convex portion overlaps the pocket in the circumferential direction and a radial direction.

3. A ball bearing comprising:
an outer ring;
an inner ring;
a plurality of the balls arranged between the outer ring and the inner ring; and
the crown cage for a ball bearing according to claim 1.
